(19) United States
(12) Patent Application Publication
(10) Pub. No.: US 2005/0063674 A1
(43) Pub. Date: Mar. 24, 2005

(54) Processor for safe processing of audio/video data and method of protecting audio/video data in audio/video data processor

(76) Inventors: Kryzysztof Bilinski, Wilkanowo (PL); Andrew N. Rybicki, Taipei (TW)

Correspondence Address: COLLARD & ROE, P.C., 1077 Northern Boulevard, Roslyn, NY, 11576-1696, US

(21) Appl. No.: 10/714,813

(22) Filed: Nov. 17, 2003

(30) Foreign Application Priority Data
Nov. 18, 2002 (PL) 357174

(51) Int. Cl. H04N 5/76; G11B 15/04; G11B 19/04

(52) U.S. Cl. 386/94; 360/60

(57) ABSTRACT

A processor (101) for safe processing of audio/video data, comprising a descrambler (102), a decoder (103), an A/V converter (104) an internal memory module (106), enabling recording at least one audio/video data stream and simultaneous playback of at least one recorded audio/video data stream with a controlled delay, a data transfer controller (105), controlling the transfer of audio/video data streams between the descrambler (102), the internal memory module (106) and the decoder (103), where the output of the descrambler (102) is connected to one of the inputs of the data transfer controller (105), one of the outputs of the data transfer controller, (105) is connected to the input of the decoder (103), the data transfer controller (105) is connected bidirectionally to the internal memory module (106), and the output of the decoder (103) is connected to the input of the A/V converter ?04). Furthermore, the processor (101) comprises an external memory interface (108). The external memory (109) is connected bidirectionally to this interface (108). The data transfer controller (106) are connected bidirectionally to this interface (108).

### BACKGROUND OF THE INVENTION

1. Field of the Invention

The current invention relates to a processor for safe processing of audio/video data and method of protecting audio/video data in the audio/video data processor, especially for processing digital television signals, such as MPEG signals, designated for application in DVR (Digital Video Recorder) or PVR (Personal Video Recorder) systems that store the received television signals.

2. Brief Description of the Background of the Invention Including Prior Art

The U.S. Pat. No. 5,977,977 “Single System Computer Having Integrated MPEG and Graphical Processors” presents a single-chip integrated computer system, comprising a CPU (Central Processing Unit) and specialized co-processors for graphical operations. The system has many advantages, such as a better utilization of resources, faster access to storage, smaller number of external connections and increased security of the processed information.

This chip is an example of one of many single-chip systems available presently on the market, which contain an integrated CPU and other blocks supporting operation of specific functions, such as managing transport of data, system control, MPEG decoding, PAL/NTSC coding, etc. From the point of view of a broadcaster of television signals, such systems do not assure safe signal processing, record and playback at the signal receiver.

The British patent application No. GB2343074 “Concurrent recording and playback of broadcast material” presents a logical organization of a PVR device, designed for concurrent recording and playback of broadcast material are presented. The device contains a signal-recording buffer for concurrent signal recording and playback, which enables a time shift between signal receipt and display. This enables watching a video transmission, for example, with a one-minute delay in relation to the broadcast signal, which is being recorded all the time. The device temporarily records a video material in the record buffer such as the external RAM or a hard disk. However, the device does not comprise means, which would increase the security of processed signals.

The U.S. Pat. No. 5,802,268, “Digital Processor with Built-in EEPROM” presents a configuration of a processor with a built-in EEPROM-type memory, as well as a method of recording and reading. information from this memory. Such a processor in many applications may not require any external memory, which simplifies system design and reduces costs. However, the presented solution describes only a method of operating the EEPROM, and is not concentrated on any specific application. Especially, it does not mention processing of audio/video data and safe data transmission between the broadcaster and the recipient of the signal.

There are many well-known methods of protecting data in PVR systems.

One of the methods utilizes additional scrambling (to the system internal format) of data recorded in the mass storage, which requires computing power and specialized systems for scrambling and descrambling operations.

Another method utilizes recording data scrambled by codes recorded on Smartcards. However, if the codes are changed by the broadcaster, data, which was scrambled by old codes, cannot be descrambled.

The known PVR systems store data in storage devices such as hard disks or memory cards. Such storage means are exposed to unauthorized access, therefore data recorded on them may be not secure. This is especially the case with the application of conventional hard disks equipped with commonly applied and accessible data interfaces, e.g. ATA.

The known digital television decoders (also called set-top boxes or integrated receiver decoders), comprise internal modules such as the signal reception block (comprising a tuner and a demodulator), external device interfaces (such as Ethernet, USB or RS-232 ports, remote control, keyboard, hard disk, Smartcard), the output TV signal coder, as well as a memory block, comprising RAM, ROM and Flash-type memories. Communication between the particular systems of such a decoder is carried out via specific data buses. The memory blocks add to the total cost of the system. Moreover, since they are external to the main system processor, data transmitted between the processor and memory may be subject to unauthorized access.

### SUMMARY OF THE INVENTION

1. Purposes of the Invention

It is an object of this invention to provide a processor for safe processing of audio/video data, allowing data to be protected from unauthorized access.

It is another object of this invention to provide a method for protecting audio/video data in the audio/video data processor, allowing the broadcaster to decide, which broadcast data can be stored only in the secure medium.

2. Brief Description of the Invention

A processor for safe processing of audio/video data, according to this invention, comprises a descrambler, a decoder, an A/V converter, an internal memory module, enabling recording at least one audio/video data stream and simultaneous playback of at least one recorded audio/video data stream with a controlled delay, a data transfer controller, controlling the transfer of audio/video data streams between the descrambler, the internal memory module and the decoder, where the output of the descrambler is connected to one of the inputs of the data transfer controller, one of the outputs of the data transfer controller is connected to the input of the decoder, the data transfer controller is connected bidirectionally to the internal memory module, and the output of the decoder is connected to the input of the A/V converter.

Furthermore, the processor can comprise an external memory interface connected bidirectionally to the external memory module, enabling recording at least one audio/video data stream and simultaneous playback of at least one recorded audio/video data stream with a controlled delay, where the external memory interface is further bidirectionally connected with the data transfer controller and the internal memory module.

In another aspect of the present invention, a method of protecting audio/video data in a processor for processing audio/video data, transmitted between the broadcaster and the receiver, with the use of a security tag, by which the selected data streams are tagged, comprises the steps of checking in the data flow controller of the processor if the received audio/video stream contains a security tag, and depending on the status of the tag, allowing the audio/video data stream to be recorded only in the internal memory of the processor or allowing the audio/video data stream to be recorded either in the internal memory of the processor or the external memory module, coupled with the processor via an external memory interface built in the processor.

Furthermore, in the event of lack of the security tag in the processed audio/video data stream, the method further comprises the step of allowing the audio/video data stream to be recorded either in the internal memory module or in the external memory module, or in another embodiment, allowing the audio/video data stream to be recorded only in the internal memory module.

Furthermore, in the event of presence and active state of the security tag in the processed audio/video data stream, the method further comprises the steps of allowing the audio/video data stream to be recorded only in the internal memory module. In the event of the presence and inactive state of the security tag in the processed audio/video data stream, the method can allow the audio/video data stream to be recorded either in the internal memory module or in the external memory module.

### BRIEF DESCRIPTION OF THE DRAWINGS

In the accompanying drawings one of the possible embodiments of the present invention is shown where:

FIG. 1 shows a schematic of an audio/video processor according to the invention;

FIGS. 2A and 2B show a memory system of a digital television decoder;

FIG. 3 shows an algorithm of a safe method of audio/video data processing with the use of a security tag.

### DESCRIPTION OF INVENTION AND PREFERRED EMBODIMENT

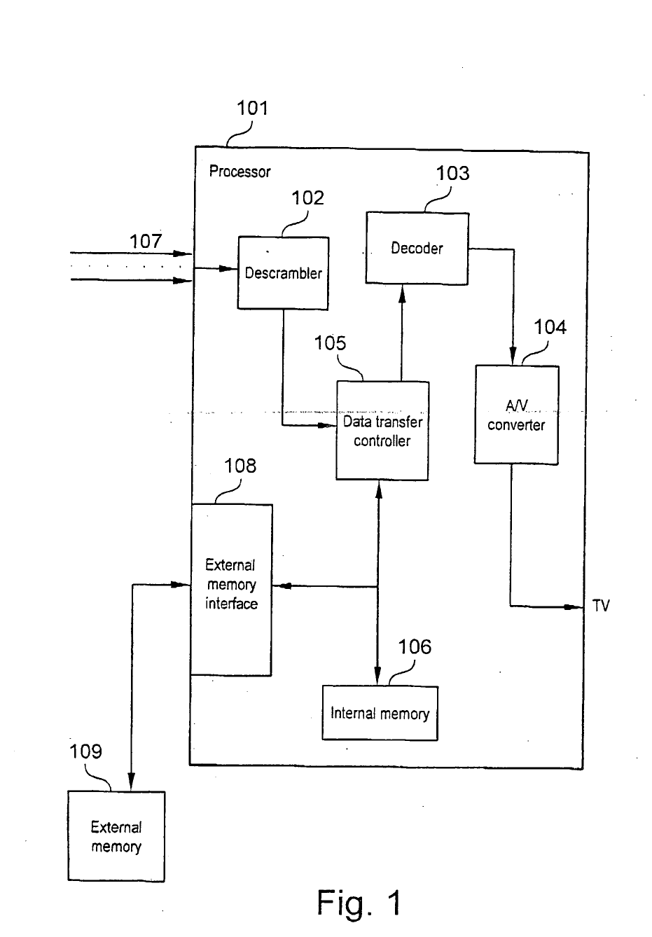

FIG. 1 shows a processor 101 for safe audio/video data processing. It comprises a descrambler 102, a decoder 103, an A/V converter 104 for converting the decoded audio/video data to the format of the TV set, a data transfer controller 105, an internal A/V memory module 106.

Scrambled and coded data are delivered to the descrambler 102 of the processor 101 via an external bus 107, as data streams, for example in MPEG format.

The output of the descrambler 102 is connected to one of the inputs of the data transfer controller 105, whose one of outputs is connected to the input of the decoder 103.

The controller 105 is also coupled bidirectionally with the internal A/V memory module 106, preferably of a large capacity. The A/V memory module 106 is designated for storage of audio/video data.

The output of the decoder 103 is connected to the input of the A/V converter 104. The A/V converter 104 is designated for converting the decoded signal to the format of the external TV set, which is connected to its output.

Furthermore, the processor 101 comprises an external memory interface 108.

The external memory module 109 is connected bidirectionally to this interface 108. The data transfer controller 105 and the internal memory module 106 are connected bidirectionally to this interface 108.

The scrambled audio/video MPEG data streams are deciphered by the descrambler 102 by means of codes stored, for example on Smartcards. The descrambled signal, is completely safe inside the processor 101, it can be transmitted to the decoder 103 or stored in the internal memory module 106.

Depending oh the settings of the device in which the processor 101 is employed (for example, a digital television decoder), the controller 105 controls transfer of data between the descrambler 102, the internal memory module 106, the external memory interface 108 and the decoder 103.

Such a processor can manage, for example, three audio/video data streams.

Two streams can be recorded, and one can be read from the internal memory 106. Such a situation may take place when the user is recording one program and watching a second one, time-shifted.

The signal from the controller 106, after decoding in the decoder 103, is linked with other elements, such as OSD graphics, and converted in the A/V converter 104 to the format of the external TV set, which is connected to its output.

The controller 105, controls the recording and playback of the MPEG data, depending on the current status of the device. The status is understood as the device configuration, i.e. the capacity of internal memory 106, the presence of an external memory 109, and configuration settings, programmed by the user of the device modules.

Depending on the needs and requirements of the user, the controller 105 may control both the internal memory module 106, as well as the external memory modules, such as hard disks. Therefore, for the needs of controlling the external memory module 109, the external memory interface 108 is also built in the processor 101.

The processor 101 for safe processing of audio/video data, according to the invention, may thus be used in the above-described method in the known digital television decoders and in other electronic systems, supporting the MPEG format.

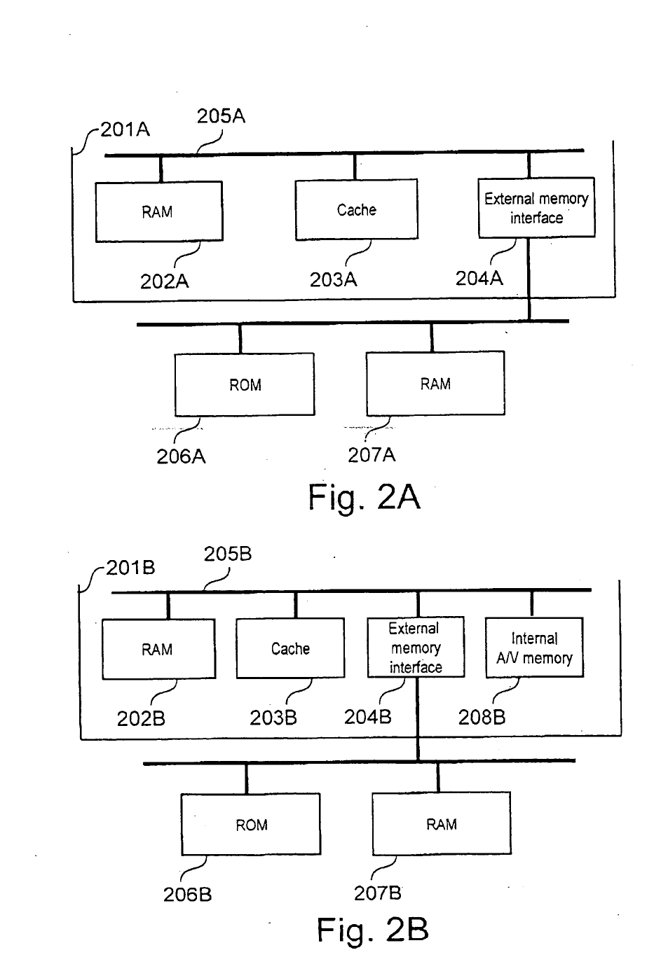

FIG. 2A shows a memory system of a device for processing audio/video data, with a standard processor. The memory system of a processor 201A employed in such a device comprises RAM 202A and Cache 203A memory blocks, as well as an external memory interface 204A. The RAM 202A and Cache 203A memory blocks are utilized to accelerate the operation of the processor, by storing the code and data which are most often executed or utilized. These systems are connected via a data bus 207A. The external memory interface 204A may operate external memory modules, either RAM-type 207A (e.g. SRAM, DRAM) and ROM-type 206 (e.g. ROM, EEPROM or Flash).

FIG. 2B shows a memory system of a device for processing audio/video data, with a processor according to the invention. The processor 201B has elements 201B-207B similar to elements of processor 201A. Moreover, it comprises an internal A/V memory 208B, which is used for storage of audio/video data streams. It may be implemented in a form of RAM or Flash-type memory.

The application of an additional storage inside the processor has many advantages, which include:
increased speed of operation of the system—data from the internal memory is transmitted by means of the internal data bus;
reduced cost of the device (e.g. a digital television decoder)—the processor with the built-in internal memory is cheaper than a standard processor coupled to an additional external memory;
reduced space occupied by chips;
if the capacity of the internal memory is large, there may be no need for external memory modules, such as a hard disk.
no need for modules controlling external memories, e.g. a storage controller or external data carriers such as a hard disk;
reduced number of processor pins, when no external memory is supported—the pins for external memory are no longer needed;

Data storage in external memory is not fully secure. By implementing the method according to the invention, which is described below, data storage security may be increased as compared to current systems. The method utilizes a processor described above, which enables to store data either in the internal memory 106 or the external memory 109.

The method allows the broadcaster to decide, which broadcast data can be stored by the user only in the secure medium, such as the internal memory module 106 of the processor 101.

To enable this, there is a security tag, transmitted in the stream, informing the digital television decoder whether the broadcast material can be recorded in the external memory module 109 or not. Data, stored in the external memory, could be copied, therefore it is not secure.

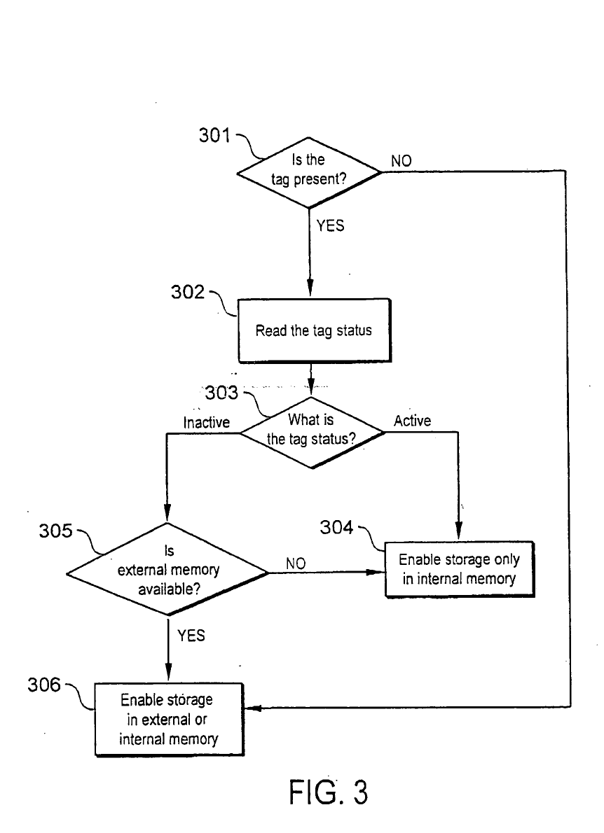

FIG. 3 shows an algorithm of a safe method of audio/video data processing with the use of a security tag.

In the first step of the procedure, 301, the controller 105 of the processor 101 checks whether the processed signal contains a security tag. If so, the tag status is read in step 302 and checked in step 303.

The tag status is used to decide if data can be recorded in the internal memory 106 only, or either in the internal memory 106 or the external memory 109 (if such memory is available).

In case the security tag is present and active, data may be stored only in the internal memory 106, which is enabled in step 304.

In case the security tag is present and inactive, it is checked whether the external memory is available 305. In case the external memory 109 is not available, data may be stored only in the internal memory 106. Otherwise, data may be stored either in external memory 109 or internal memory 106.

In case the security tag is not transmitted by the broadcaster, data can be recorded either in the internal memory 106 or in the external memory 109, as it is shown in FIG. 3. In another embodiment (not shown in the drawing), providing increased security of data, when the tag is not transmitted, data might be stored only in the internal memory module 106.

The solutions according to the invention allow for safe processing of audio/video data transmitted between the broadcaster and the receiver, such as data related to television programs.

Integration of the internal memory module in the processor, contributes to the simplification of the construction of the entire device, which, in effect, results in a decrease of failure probability and costs reduction.

The security of the stored data is increased due to the fact that data is accessible only to the processor and may not be read from outside for unauthorized copying. Since data stored in the internal memory is secure, it may be stored in a descrambled form, which makes its processing considerably easier.

The internal memory module preferably has a large capacity allowing for provide the functionality of a typical PVR system. The current technology allows for producing a solid memory storage with a capacity of a few Gigabytes. However, with a further increase of its capacity and reduction of the size of the chip, it will be possible to equip the processor, with the memory of capacity of several dozens or several hundreds of Gigabytes, which could easily replace expensive external devices, used currently for storing data in the PVR systems.

Processors, utilized in present PVR systems, operate external device storing data, thus they must be equipped with an interface for communication with the storage device. If, however, according to the invention, a large capacity storage is applied in the processor itself, it may be no longer necessary to utilize external memory, as well as its interface (for example, ATA in case of hard disks).

The method according to the invention allows the broadcaster to label the broadcast programs with a security tag, so that the content not designated for copying, e.g. prime films, is not accessible in the digital form outside of the processor. On the other hand, the content, which is acknowledged by the broadcaster as allowed to be copied, e.g. news or advertisements, may be stored on external memory carriers.

1. A processor for safe processing of audio/video data, comprising
a descrambler
a decoder
an A/V converter
an internal memory module, enabling recording at least one audio/video data stream and simultaneous playback of at least one recorded audio/video data stream with a controlled delay,
a data transfer controller, controlling the transfer of audio/video data streams between the descrambler, the internal memory module and the decoder,
where the output of the descrambler is connected to one of the inputs of the data transfer controller, one of the outputs of the data transfer controller is connected to the input of the decoder, the data transfer controller is connected bidirectionally to the internal memory module, and the output of the decoder is connected to the input of the A/V converter.

2. The processor according to claim 1, further comprising
an external memory interface connected bidirectionally to the external memory module, enabling recording at least one audio/video data stream and simultaneous playback of at least one recorded audio/video data stream with a controlled delay,
where the external memory interface is further bidirectionally connected with the data transfer controller and the internal memory module.

3. A method of protecting audio/video data in a processor for processing audio/video data,
transmitted between the broadcaster and the receiver, with the use of a security tag, by which the selected data streams are tagged, the method comprising the steps of
checking in the data flow controller of the processor if the received audio/video stream contains a security tag,
and depending on the status of the tag,
allowing the audio/video data stream to be recorded only in the internal memory of the processor
or allowing the audio/video data stream to be recorded either in the internal memory of the processor or external memory module, coupled with the processor via an external memory interface built in the processor.

4. The method, according to claim 3, further comprising the steps of
in the event of lack of the security tag in the processed audio/video data stream, allowing the audio/video data stream to be recorded either in the internal memory module or in the external memory module.

5. The method, according to claim 3, further comprising the steps of
in the event of lack of the security tag in the processed audio/video data stream, allowing the audio/video data stream to be recorded only in the internal memory module.

6. The method, according to claim 3, further comprising the steps of
in the event of presence and active state of the security tag in the processed audio/video data stream, allowing the audio/video data stream to be recorded only in the internal memory module.

7. The method, according to claim 3, further comprising the steps of
in the event of the presence and inactive state of the security tag in the processed audio/video data stream, allowing the audio/video data stream to be recorded either in the internal memory module or in the external memory module.
